(19) United States
(12) Patent Application Publication
(10) Pub. No.: US 2018/0354222 A1
(43) Pub. Date: Dec. 13, 2018

(54) FORM AND SEAL PACKAGING MACHINE FOR PRODUCING POLYGONAL SLEEVE WITH REINFORCED CORNERS

(71) Applicant: KHS USA, Inc., Sarasota, FL (US)

(72) Inventors: Roger Calabrese, Bradenton, FL (US); Mike Schaap, Oostburg, WI (US); Benjamin Wynveen, Oostburg, WI (US)

(73) Assignee: KHS USA, Inc., Sarasota, FL (US)

(21) Appl. No.: 16/002,639

(22) Filed: Jun. 7, 2018

Related U.S. Application Data
(60) Provisional application No. 62/517,112, filed on Jun. 8, 2017.

(51) Int. Cl. B31B 70/26; B31B 70/64

(52) U.S. Cl. CPC B31B 70/262; B31B 2150/10; B31B 70/64

(57) ABSTRACT

A packaging machine feeds a sheet of packaging material along a polygonal forming column through corner folding and sealing assemblies, resulting in the formation of a polygonal sleeve with at least one reinforced corner. The polygonal sleeve is cut into sleeve sections of predetermined length by a cutting assembly.

### CROSS-REFERENCE TO RELATED APPLICATION

This application claims the benefit of U.S. Provisional Patent Application Ser. No. 62/517,112, filed on Jun. 8, 2017, the contents of which are herein incorporated by reference in their entirety.

### FIELD OF THE INVENTION

The present invention relates to sleeve-forming packaging machines, and more particularly, to packaging machines forming sleeves from a continuous sheet fed onto a forming column.

### BACKGROUND OF THE INVENTION

It is known in the packaging industry to form packages by wrapping a sheet of material about a forming column such that its sides overlap and its leading edge advances down the column. The overlapping sides are sealed to form a seam, and the leading edge is sealed to form a bottom end of the package after the leading edge advances beyond an end of the column. In some packaging applications, product is passed through the forming column, such that the package is filled with the product immediately after the leading edge is sealed. The filled package is then sealed again and cut to form a top end, as well as bottom end of the next package. In other applications, the unfilled and partially- or un-sealed package sleeve is moved elsewhere for filling and/or other operations.

While such packages can be formed very quickly and efficiently, the package design options are quite limited. For example, such packages usually cannot be displayed standing on-end without support. Likewise, the packages typically cannot be displayed in vertical stacks. It would be desirable to have a packaging machine permitting the forming of sturdier sleeves of more complex geometry on a forming column.

### SUMMARY OF THE INVENTION

In view of the foregoing, it is an object of the present invention to provide a packaging machine for producing a polygonal sleeve with one or more reinforced corners. According to an embodiment of the present invention, a packaging machine comprises a forming column, a feed mechanism, a corner folding assembly and a sealing assembly.

The forming column extends in a forming direction from a first column end to second column end and has a polygonal cross-section perpendicular to the forming direction, the polygonal cross-section defining at least three sides separated by at least three corners. The feed mechanism is configured to feed a sheet of packaging material onto the first column end such that the sheet wraps completely around the forming column with a leading edge of the sheet directed toward the second column end and overlapping sides of the sheet forming a seam extending in the forming direction.

The corner folding assembly is arranged around the forming column between the first and second column ends, and is configured to engage the sheet of packaging material such that, at one or more of the at least three corners, a folded portion of the sheet is formed extending in the forming direction.

The sealing assembly is arranged around the forming column between the corner folding assembly and the second column end, and is configured to engage the at least one corner to seal the folded portion to an underlying portion of the sheet and to seal the seam, forming a polygonal sleeve with at least one reinforced corner.

These and other objects, aspects and advantages of the present invention will be better appreciated in view of the drawings, and following description of preferred embodiments.

### BRIEF DESCRIPTION OF THE DRAWINGS

FIG. 1 is a perspective view of a packaging machine including a forming column, corner folding assembly and sealing assembly, according to an embodiment of the present invention;

FIG. 2 is a sectional view through the forming column of FIG. 1 taken at a first point of the corner folding assembly;

FIG. 3 is a sectional view through the forming column of FIG. 1 taken at a second point of the corner folding assembly, the second point being further advanced down the forming column assembly than the first point;

FIG. 4 is a perspective view of the corner folding assembly of FIG. 1;

FIG. 5 a perspective view of the corner folding assembly of FIG. 1, including a sheet of packaging material passing therethrough;

FIG. 6 is a perspective view of the sealing assembly of FIG. 1;

FIG. 7 is a sectional view through the forming column of FIG. 1 taken through the sealing assembly with sealing bars thereof in a retracted position; and

FIG. 8 is a sectional view through the forming column of FIG. 1 taken through the sealing assembly with sealing bars thereof in an extended position.

### DETAILED DESCRIPTION OF PREFERRED EMBODIMENTS

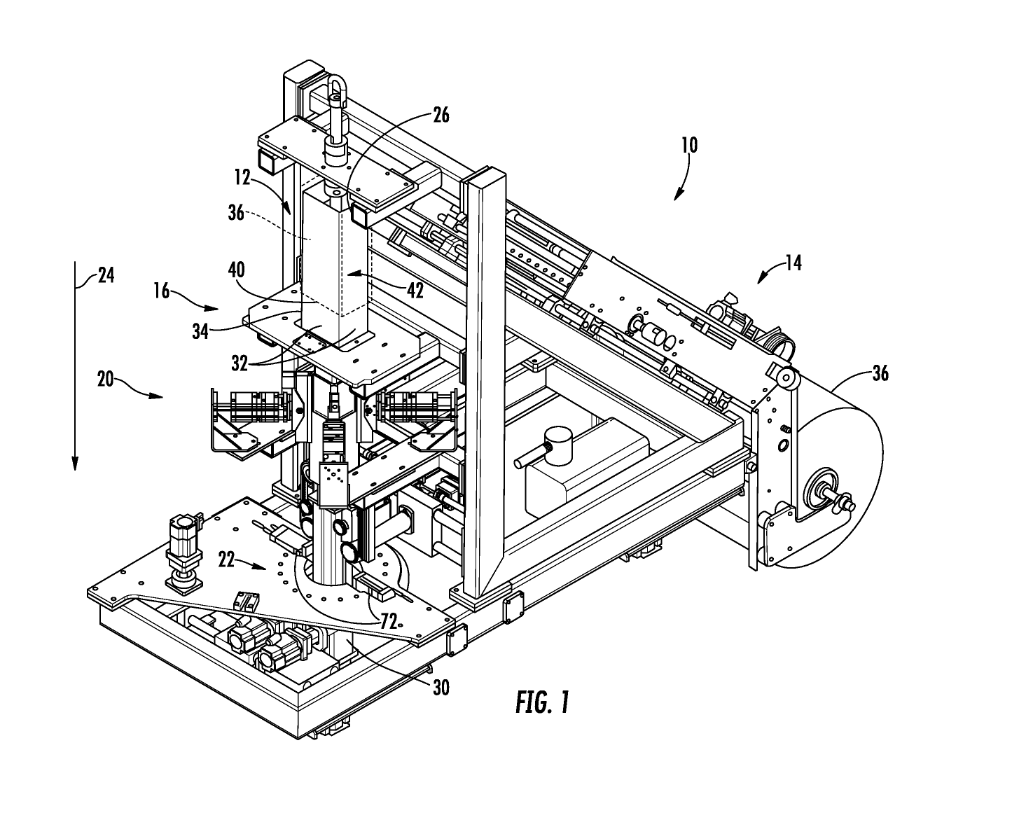

Referring to FIG. 1, according to an embodiment of the present invention, a packaging machine 10 includes a forming column 12, a feed mechanism 14, a corner folding assembly 16, a sealing assembly 20 and cutting assembly 22. The forming column extends in a forming direction 24 between first and second column ends 26, 30. Perpendicular to the forming direction 24, the forming column has a polygonal cross-section defining a plurality of sides 32 and separated by respective corners 34.

The feed mechanism 14 feeds a sheet 36 of packaging material onto the first column end 26, such that the sheet 36 wraps around the forming column 12 with its leading edge 40 proceeding toward the second column end 30, with overlapping sides of the sheet 36 forming a seam 42 extending in the forming direction 24.

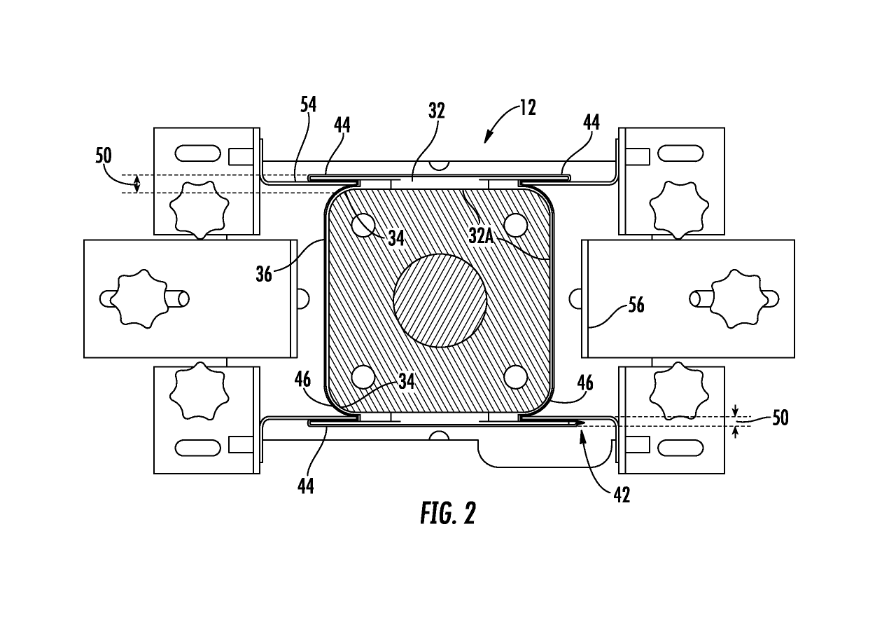

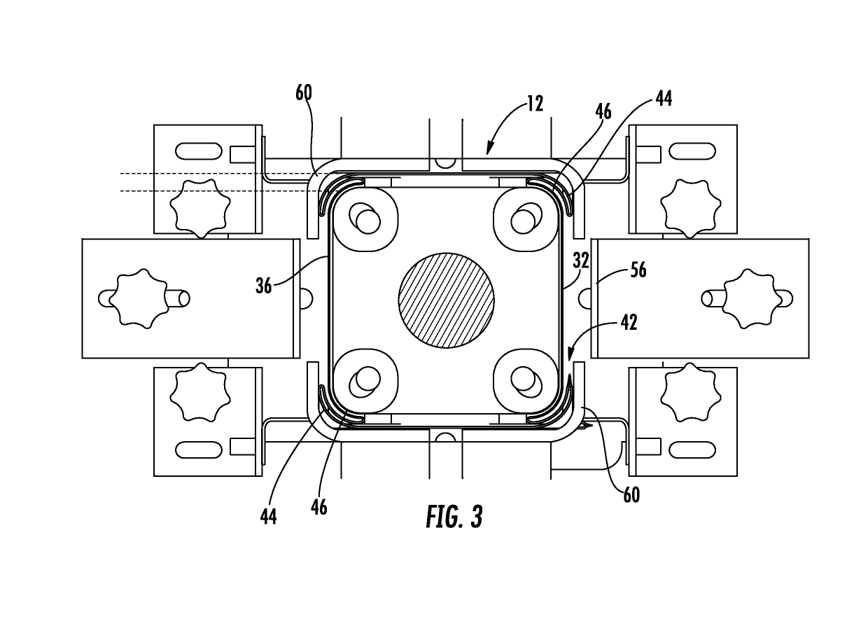

Referring also to FIGS. 2 and 3, the corner folding assembly 16 is arranged around the forming column 12 between the first and second column ends 26, 30. The corner folding assembly 16 engages the sheet 36 to form a folded portion 44, extending in the forming direction 24, at one or more corners 34 of the forming column 12.

The sealing assembly 20 is arranged around the forming column 12 between the corner folding assembly 16 and the second column end 30. The sealing assembly 20 is configured to engage the sheet 36 at the corners 34 to seal the seam 42 and to seal the folded portions 44 to the underlying portions 46 of the sheet 36. Consequently, a polygonal sleeve is formed extending around the forming direction 24 with one or more reinforced corners.

The cutting assembly 22 is arranged between the sealing assembly 20 and the second column end 30, and cuts predetermined lengths off the polygonal sleeve perpendicular to the forming direction 24, which sleeve sections can be removed from the second column end 30 for further processing. Advantageously, each sleeve section thus formed is open at both ends, and polygonal in cross section with a plurality of reinforced, corners extending in parallel between the open ends thereof.

The depicted forming column 12 has four sides and corners, although it will be appreciated that the present invention is not necessarily limited thereto; forming columns with any number of sides and corners three or greater could be used to form any corresponding polygonal shape. To define the desired number of sides and corners it is not necessary that the forming column be completely solid across the sides and/or corners around the entire perimeter and/or length of the column. Additionally, the forming column 12 is oriented vertically in the depicted embodiment, although other orientations could be used.

As will be explained in greater detail below, one or more sides 32 of the forming column 12 advantageously transitions inwardly at the corner folding assembly 16. As seen in FIG. 2, there is a transition from the side 32 at an outer position to a side 32A at an inner position, such that a width gap 50 exists therebetween. Additionally, a shape of the corners 34 of the forming column 12 advantageously transitions from perpendicular before the corning folding assembly 12 to radiused thereafter.

The sheet 36 of packaging material is preferably fed onto the forming column 12 by the feed mechanism 14 such that the seam 42 is located at one of the corners 32. As a result, the seam 42 can be sealed by the sealing mechanism 20 simultaneously with the sealing of the corresponding folded portion 44 of the sheet 36 to the underlying portion 46.

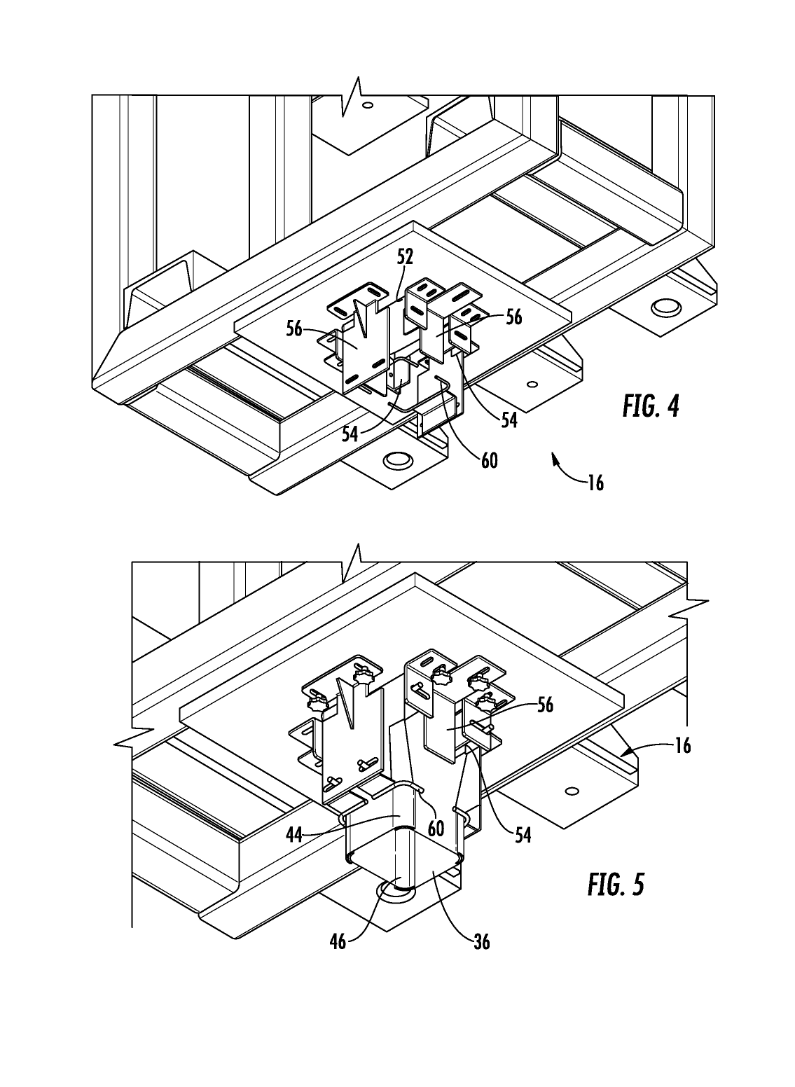

Referring to FIGS. 2-5, the corner folding assembly defines 16 a central aperture 52 through which the forming column 12 extends. First folding fins 54 are located extending into the width gaps 50 at the corners 34 from opposite sides of the aperture 52 to form the folded portions 44, while second folding fins 56, perpendicular to the first folding fins 54, urge the sheet 26 towards opposite sides 32A of the forming column, further delineating the folded portions 44 from the underlying portions 46. Further along the folding direction 24 from the fins 54, 56, the corner folding assembly includes radiused bars 60, which urge the folded portions 44 onto the underlying portions 46 and the now radiused corners 34 of the forming column 12.

The depicted corner folding assembly 16 forms folded portions 44 at all the corners 34 of the forming column 12. However, the present invention could also employ a corner folding assembly that formed folded portions at less than all of the corners 34.

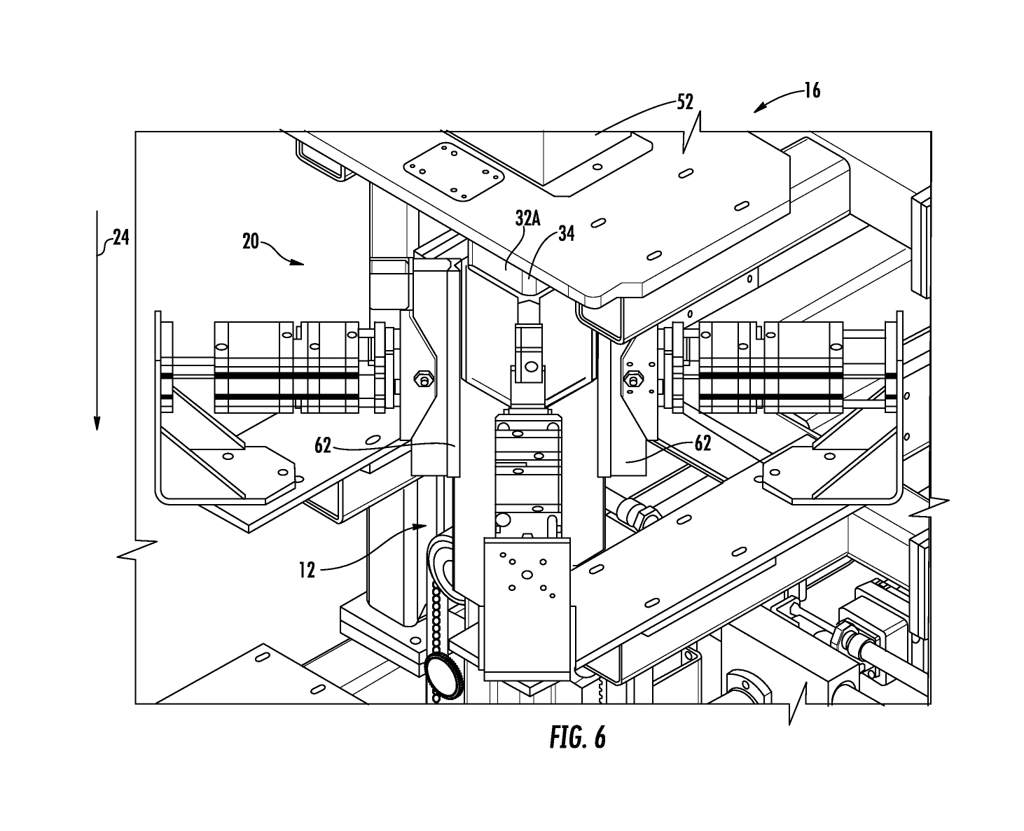

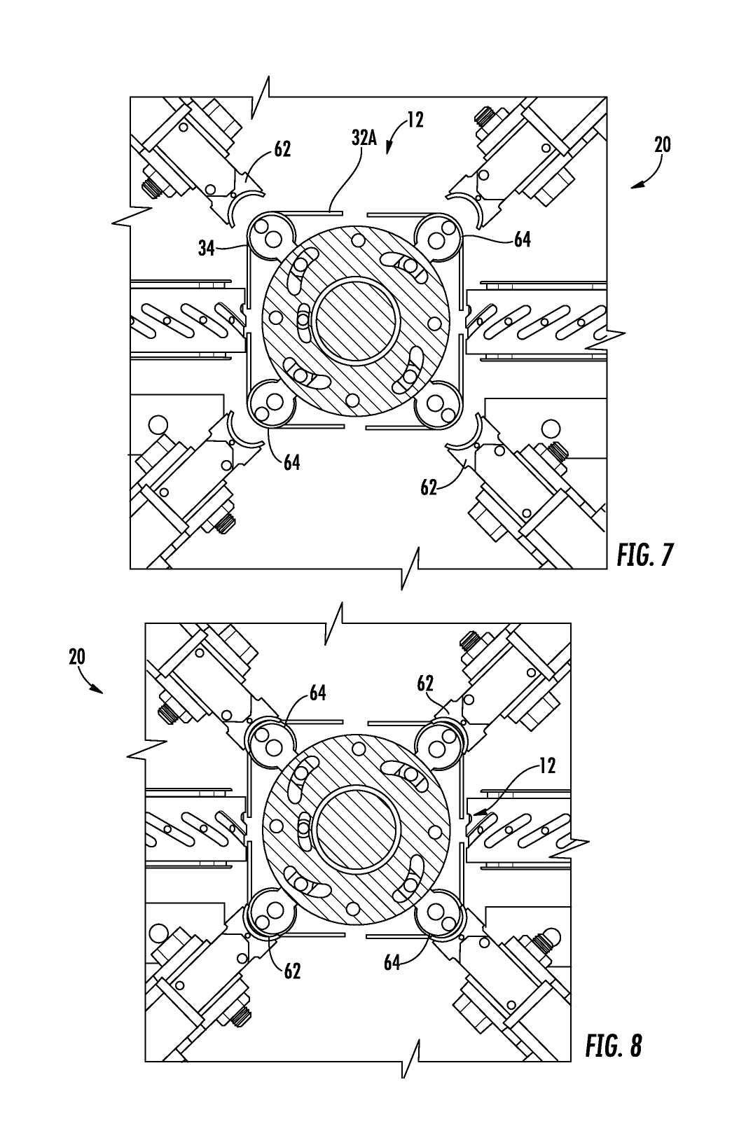

Referring to FIGS. 6-8, the sealing assembly 20 includes external and internal sealing bars 62, 64 with complementary radiused faces separated by the radiused corners 34 of the forming column (or complementing another desired corner profile; e.g., square). Each external sealing bar 62 is movable in unison between retracted (FIG. 7) and extended (FIG. 8) positions. In the extended positions, the sealing bars 62, 64 engage across the folded portions 44 of the sheet 36 and seal them to the underlying portions 46, as well as sealing the seam 42 located at one of the corners 34. Preferably, the sealing bars 62, 64 are heated, with more heat applied to the sealing bars 62, such that retraction thereof not only permits further advancement of the sheet 36 in the forming direction 24, but also prevents unwanted melting of the sheet 36 during temporary pauses in the forming process.

Referring again to FIG. 1, the cutting assembly 22 includes opposed knives 72 rotatably mounted about the forming column 12 after the sealing assembly 20. Each knife 72 engages the sheet 36 in a common plane perpendicular to the forming direction 24. With 180 degrees of knife 72 rotation about the column 12, a section is completely separated from the remainder of the sheet 36. The sheet 36 can then be transported by other means for further processing. As discussed above, each sleeve section has a polygonal cross section with one or more reinforced corners. Preferably, the corners all extend substantially in parallel with each other.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. A packaging machine comprising:
a forming column extending in a forming direction from a first column end to second column end, the forming column having a polygonal cross-section perpendicular to the forming direction, the polygonal cross-section defining at least three sides separated by at least three corners;
a feed mechanism configured to feed a sheet of packaging material onto the first column end such that the sheet wraps completely around the forming column with a leading edge of the sheet directed toward the second column end and overlapping sides of the sheet forming a seam extending in the forming direction;
a corner folding assembly arranged around the forming column between the first and second column ends, the corner folding assembly configured to engage the sheet of packaging material such that, at at least one of the at least three corners, a folded portion of the sheet is formed extending in the forming direction; and
a sealing assembly arranged around the forming column between the corner folding assembly and the second column end, the sealing assembly being configured to engage the at least one corner to seal the folded portion to an underlying portion of the sheet and to seal the seam, forming a polygonal sleeve with at least one reinforced corner.

2. The packaging machine of claim 1, wherein the feed mechanism is configured to feed the sheet onto the forming column such that the seam is located at one of the at least three corners.

3. The packaging machine of claim 2, wherein the feed mechanism is configured feed the sheet onto the forming column such that the seam is located at least at the at least one corner where the folded portion is formed, and the sealing assembly is configured to seal the seam by sealing the folded portion to the underlying portion of the sheet.

4. The packaging machine of claim 1, wherein the corner folding assembly is configured to engage the sheet of packaging material at least at two of the at least three corners to form respective folded portions of the sheet thereat extending in the forming direction, and the sealing assembly is configured to engage the at least two corners to seal the respective folded portions to respective underlying portions of the sheet, forming the polygonal sleeve with at least two reinforced corners.

5. The packaging machine of claim 4, wherein the at least two reinforced corners extend in parallel.

6. The packaging machine of claim 4, wherein the corner folding assembly is configured to engage the sheet of packaging material at all of the at least three corners to form respective folded portions of the sheet thereat extending in the forming direction, and the sealing assembly is configured to engage all of the at least three corners to seal the respective folded portions to the respective underlying portions of the sheet.

7. The packaging machine of claim 6, wherein the polygonal cross-section of the forming column defines four sides separated by four corners, the corner folding assembly is configured to engage the sheet of packaging material at all four corners to form respective folded portions of the sheet thereat extending in the forming direction, and the sealing assembly is configured to engage all four corners to seal the respective folded portions to the respective underlying portions of the sheet.

8. The packaging machine of claim 1, wherein, at the corner folding assembly, a side of the forming column adjacent to the at least one corner transitions from an outer location to an inner location such that a width gap perpendicular to the forming direction is defined between planes of the outer and inner locations, the corner folding assembly including a folding fin located in the width gap between the inner and outer locations, the folding fin engaging the sheet during travel in the forming direction to form the folded portion.

9. The packaging machine of claim 8, wherein, along the at least one corner, the forming column is radiused after the transition of the side from the outer to the inner location.

10. The packaging machine of claim 9, wherein the corner folding assembly further includes a radiused bar disposed outwardly of the at least one corner following the folding fin, the radiused bar being positioned to urge the folded portion onto the underlying surface in a radiused geometry.

11. The packaging machine of claim 1, wherein the sealing assembly includes at least one external sealing bar extending in parallel with the forming direction, the at least one external sealing bar being mounted outside the forming column so as to be movable between a sealing position, engaging the at least one corner to seal the folded portion to the underlying portion, and a retracted position, separated from the at least one corner to allow the sheet to advance in the forming direction.

12. The packaging machine of claim 11, wherein the sealing assembly further includes at least one internal sealing bar extending in parallel with the forming direction, the at least one internal sealing bar being mounted inside the forming column opposite the at least one external sealing bar.

13. The packaging machine of claim 12, wherein at least one of the external and internal sealing bars is heated.

14. The packaging machine of claim 13, wherein both of the external and internal sealing bars are heated.

15. The packaging machine of claim 12, wherein the corner folding assembly is configured to engage the sheet of packaging material at all of the at least three corners to form respective folded portions of the sheet thereat extending in the forming direction, and the sealing assembly including external and internal sealing bars at all of the at least three corners, each of the external and internal sealing bars extending in parallel with the forming direction and each of the external sealing bars being mounted so as to be movable between the sealing and retracted positions.

17. The packaging machine of claim 11, wherein the at least one corner and the at least one external sealing bar have opposed radiused faces so as to seal the folded portion to the underlying portion in a radiused geometry.

18. The packaging machine of claim 1, further comprising a cutting assembly arranged around the forming column between the sealing assembly and the second column end, the cutting assembly being configured to cut off a predetermined length of the polygonal sleeve.

19. The packaging machine of claim 18, wherein the predetermined length of the polygonal sleeve is open on both ends.
